(19) United States
(12) Patent Application Publication
(10) Pub. No.: US 2008/0296853 A1
(43) Pub. Date: Dec. 4, 2008

(54) Stair assist robot mechanism and method

(76) Inventors: Christopher J. Langford, Wakefield, MA (US); Jennifer R. Sarkis, Chelmsford, MA (US); Charles Edwin Dean, Shrewsbury, MA (US); John Walden, Madison, AL (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/809,598

(22) Filed: Jun. 1, 2007

(51) Int. Cl. B25J 11/00

(52) U.S. Cl. 280/5.22; 901/1; 901/27; 901/30

(57) ABSTRACT

A mobile robot with a chassis including one or more drive mechanisms and at least a first arm pivotably connected to the chassis and configured to pitch up and down. A ski structure is attached on an underside of the first arm for raising the chassis as the arm is pitched down so the drive mechanisms can traverse a riser in the path of the chassis.

### FIELD OF THE INVENTION

This subject invention relates to robots, remote controlled mobile robots in particular, and a mechanism which assists a mobile robot in climbing stairs.

### BACKGROUND OF THE INVENTION

Robotic engineers have long designed different robot configurations for climbing stairs with varying degrees of success. Often, the stair climbing components of the robot interfere with other operations carried out by the robot. See U.S. Pat. Nos. 4,993,912 and 7,011,171. Some stair climbing robots have side tracks and also specialized rotateable stair climbing tracks which assist the robot in climbing stairs. These stair climbing tracks, however, add to the cost and complexity of the robot and may interfere with or limit other robot operations in the field.

### SUMMARY OF THE INVENTION

It is therefore an object of this invention to provide a new mobile robot able to climb stairs.

It is a further object of this invention to provide such a mobile robot which does not require the addition of specialized stair climbing tracks or other complex stair climbing components.

It is a further object of this invention to provide such a robot which, although, able to climb stairs, is still configured to carry out other operations in the field.

The subject invention results from the realization that when a mobile robot includes, as many do, a working robot arm (typically equipped with an end effector), a ski like structure added to the underside of the arm can be used to assist the robot in stair climbing operations. In one example, when the robot approaches a stair riser, the working robot arm is lowered until the ski contacts the second tread of the staircase. As the robot is maneuvered closer to the first stair riser, the ski raises the front end of the robot sufficiently so the side tracks can climb the first stair.

The subject invention, however, in other embodiments, need not achieve all these objectives and the claims hereof should not be limited to structures or methods capable of achieving these objectives.

The subject invention features a mobile robot comprising a chassis including one or more drive mechanisms, at least a first arm pivotably connected to the chassis and configured to pitch up and down, and a ski structure on an underside of the first arm for raising the chassis as the arm is pitched down so the drive mechanisms can traverse a riser in the path of the chassis.

In one particular example, the drive mechanisms include side tracks. There may be a second robot arm pivotably connected to the first arm. In one example, the second arm includes at least one camera and at least one end effector.

Typically, the ski structure is releasably connected to the first arm. There may be snap fit receptacles which receive therein structure of the first arm. Preferably, the ski structure includes a forward angled toe and a rearward angled heel. The preferred ski structure may also include an anti-slide feature thereon for preventing sliding of the ski structure with respect to the robot arm. In one example, the ski structure includes a snap fit receptacle which receives therein the first arm and the anti-slide feature includes a cut out in a side of the snap fit receptacle. The preferred ski structure may also include an anti-rotation feature thereon for preventing rotation of the ski structure with respect to the robot arm. In one example, the ski structure includes a snap fit receptacle which receives therein the first arm and the anti-rotation feature includes an orifice in the snap fit receptacle. The ski structure may also include a forward guard portion. Ties may be included for securing the ski structure to the first arm.

The subject invention also includes a method of climbing stairs with a mobile robot equipped with at least a first pivotable arm. The preferred method includes equipping the first pivotable arm with a ski structure, maneuvering the mobile robot to a position proximate a set of stairs, lowering the first pivotable arm until the ski structure contacts the tread of a stair, and maneuvering the mobile robot closer to the stairs whereupon the ski structure causes the mobile robot to raise and climb the first stair. The method may further include the step of raising the first pivotable arm after the mobile robot begins to climb the stairs.

The subject invention also features a stair assist mechanism for a mobile robot. The preferred mechanism comprises a ski structure including a receptacles (e.g., snap fit receptacles) which receive therein an arm of the mobile robot. A forward upwardly angled toe is on the ski structure, and a rearward upwardly angled heel is also on the ski structure. The ski structure may include an anti-slide feature thereon for preventing sliding of the ski structure with respect to the robot arm. One anti-slide feature includes a cut out in a side of a receptacle. The ski structure may also include an anti-rotation feature thereon for preventing rotation of the ski structure with respect to the robot arm. One anti-rotation feature includes an orifice in a receptacle. The ski structure may also include a forward guard portion. Ties may be provided for securing the ski structure to the robot arm.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a highly schematic side view showing a robot in accordance with the prior art approaching the first riser of the staircase.

FIG. 2 is a highly schematic side view showing a robot in accordance with the subject invention also approaching the first riser of a staircase but now the robot is equipped with a ski like structure stair climbing assist mechanism;

FIG. 3 is a highly schematic side view showing the robot of FIG. 2 with its front end now lifted by the ski mechanism;

FIG. 4 is a schematic three-dimensional side view showing an example of a particular robot equipped with a particular ski configuration in accordance with the subject invention;

FIG. 5 is a schematic three-dimensional front view showing the ski structure attached to the robot arm of FIG. 4;

FIG. 6 is a schematic three-dimensional side view showing how the ski structure shown in FIGS. 4 and 5 assists the robot in climbing a staircase;

FIG. 7 is a schematic three-dimensional side view showing how the robot equipped with the ski structure in accordance with the subject invention is now able to climb a set of stairs;

FIG. 8 is a schematic three-dimensional side view of the robot shown in FIGS. 4-7 climbing an obstacle in accordance with the subject invention;

FIG. 9 is a schematic three-dimensional side view showing an embodiment of a stair climbing assist ski structure in accordance with one example of the subject invention;

FIG. 10 is a schematic three-dimensional top view of the ski structure shown in FIG. 9;

FIG. 11 is a schematic three-dimensional view of an embodiment of a stair climbing assist ski in accordance with this invention;

FIG. 12 is a schematic three-dimensional side view of the ski shown in FIG. 11; and

FIG. 13 is a schematic three-dimensional top view of the ski shown in FIGS. 11-12.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

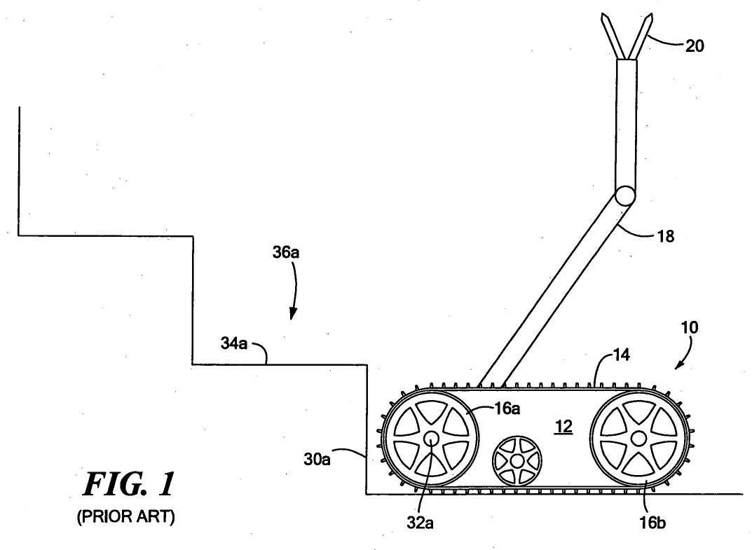

FIG. 1 shows robot 10 with chassis 12 and side drive mechanisms in a form of track 14 driven by wheels 16a and 16b. Robot 10 includes working robot arm 18 with end effector 20. Such a robot configuration is fairly common and includes the applicant's TALON® robot (Foster-Miller, Inc., Waltham, Mass.). When robot 10 approaches stair riser 30a, the centerline of wheel 16a axle 32a is below tread 34a and thus robot 10 is incapable of or has difficulty climbing stair 36a.

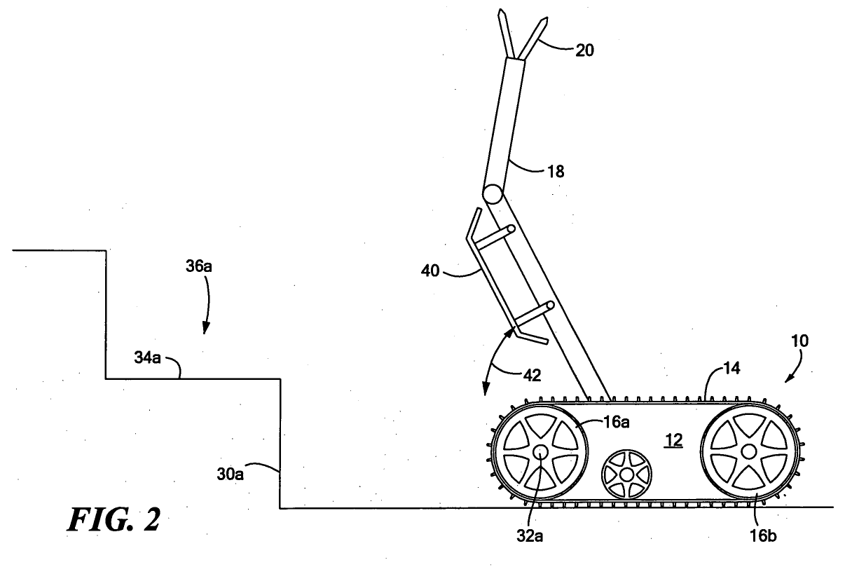

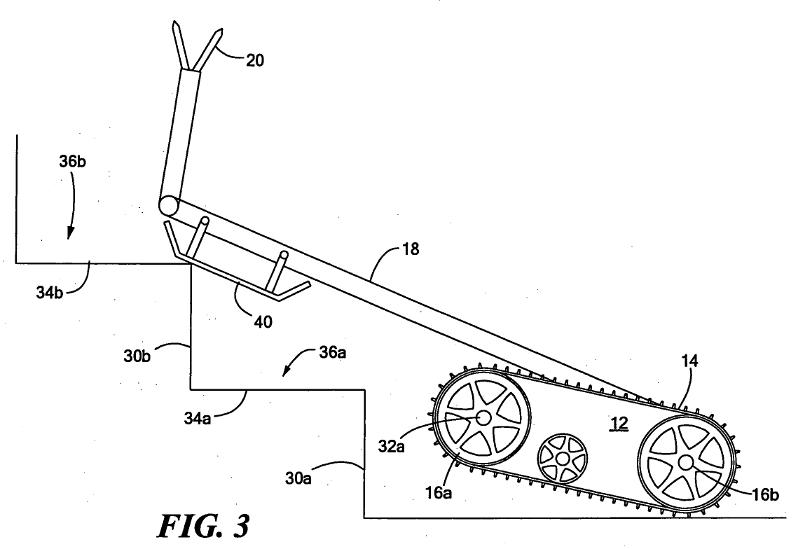

In accordance with the subject invention, robot 10, FIG. 2 now includes ski structure 40 on the underside of arm 18. Arm 18 is pivotably connected to chassis 12 and is configured to pitch up and down in the direction of arrow 42. Robot 10 is maneuvered (typically by remote control) to a position proximate stair riser 30a and, as shown in FIG. 3 arm 18 is lowered until ski structure 40 contacts tread 34b of the next stair 36b. As robot 10 then continues to maneuver closer to stair riser 30a, ski structure 40 causes front wheel 16a to rise and now axle 32a is sufficiently elevated so robot 10 can climb stair 36a. Typically, arm 18 can then be raised once robot 10 begins to climb stairs 36a and 36b.

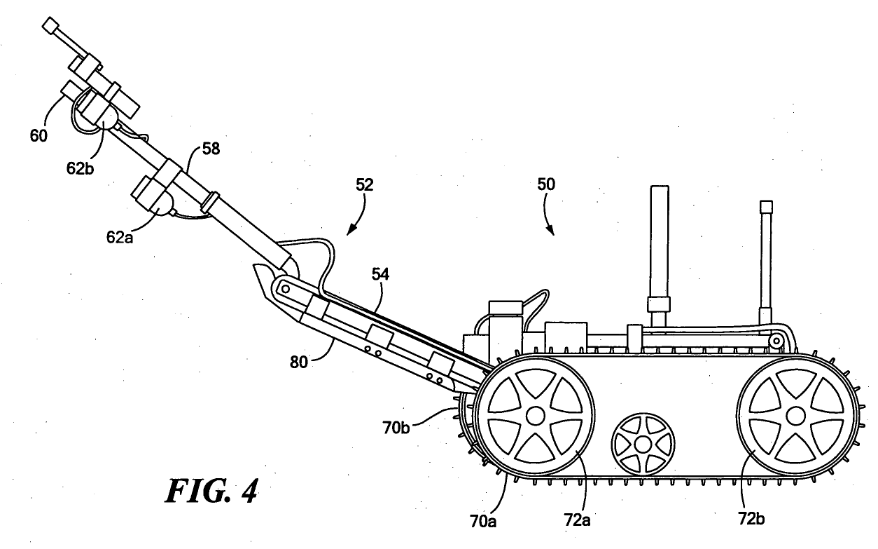

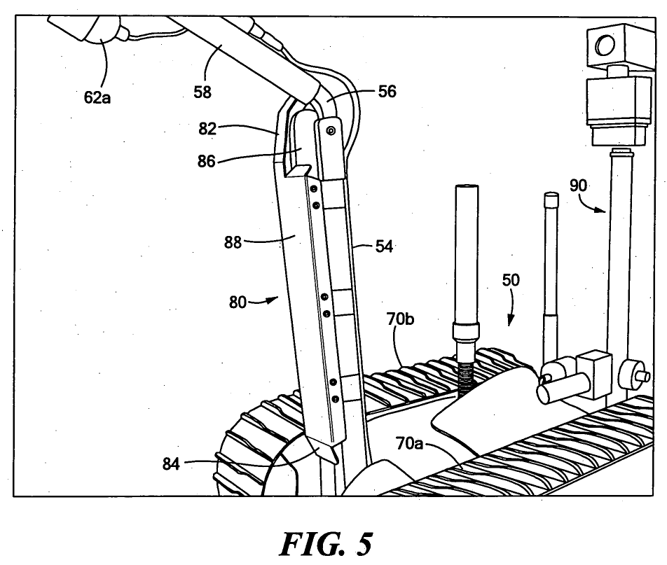

In one particular example, the robot is a Talon® brand remotely controlled mobile robot 50, FIG. 4. Working arm 52 includes first arm portion 54, second arm portion 58 pivotably connected to first arm portion 54 by elbow 56, and wrist 60 typically equipped with an end effector (not shown). Cameras 62a and 62b assist the operator in remotely controlling robot 50. Side tracks 70a and 70b are driven by motor driven wheels 72a and 72b as shown for track 70a. Here, arm portion 54 is equipped with removable quick attach ski structure 80 also shown in FIG. 5. Ski 80 includes forward upwardly angled toe 82 and rearward upwardly angled heel 84. Toe 82 covers and protects chain guard 86 and is cut out from the extent of ski body portion 88 as shown to provide clearance when arm portion 54 is folded backward and down and camera arm 90 is folded forward and down within the chassis of the robot.

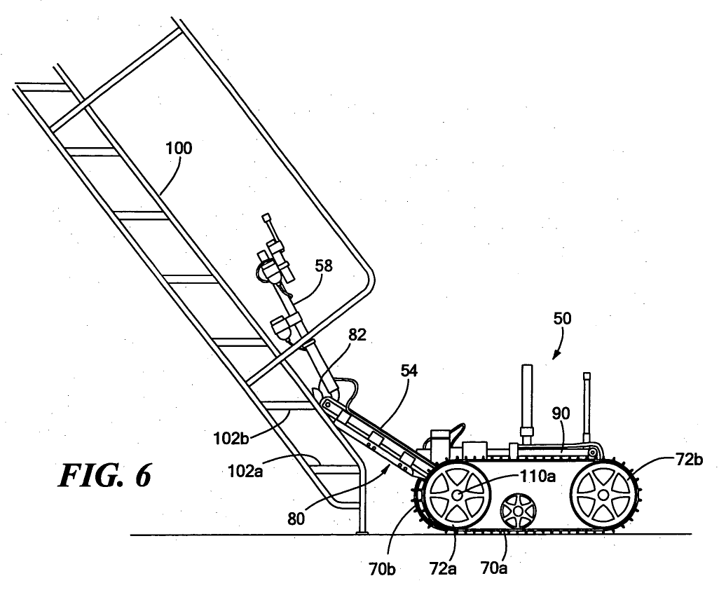

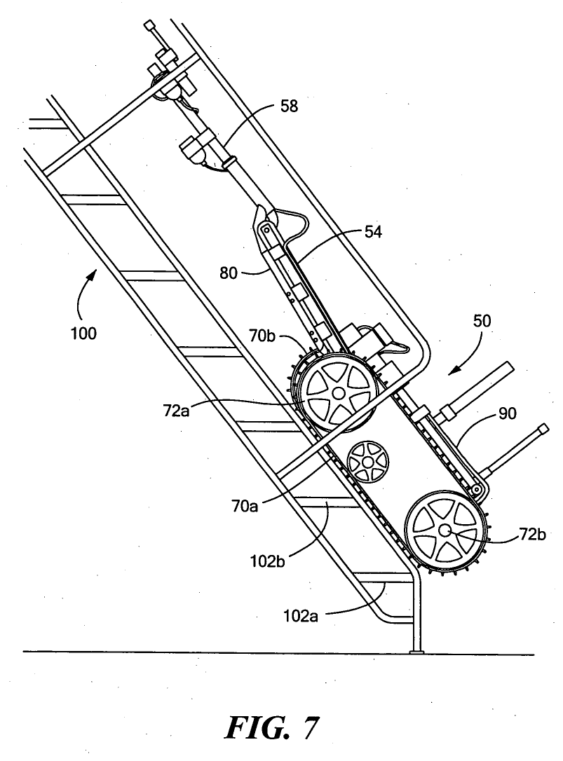

In FIG. 6, robot 50 is approaching steeply angled staircase 100 and ski 80 is lowered by arm portion 54 to contact stair tread 102b. As the robot is driven further forward towards staircase 100, ski 80 raises the front end of robot 50 lifting axle 10a sufficiently so tracks 70a and 70b are able to grab and climb tread 102a. As robot 50 is driven further forward, it begins to climb staircase 100 as shown in FIG. 7 and arm 54 and ski 80 can be raised. In reverse, when robot 50 is driven back down staircase 100, ski 80 may again be lowered to assist robot 50 in maneuvering off the last few steps of the staircase to the ground.

Note how, according to this method, robot 50 is able to climb even steep staircase 100 without the addition of specialized, motorized, or complex stair climbing tracks or other complex stair climbing equipment. Also, ski 80 does not interfere with the other operations carried out by robot 50 including the manipulation and maneuvering of arm portions 54 and 58.

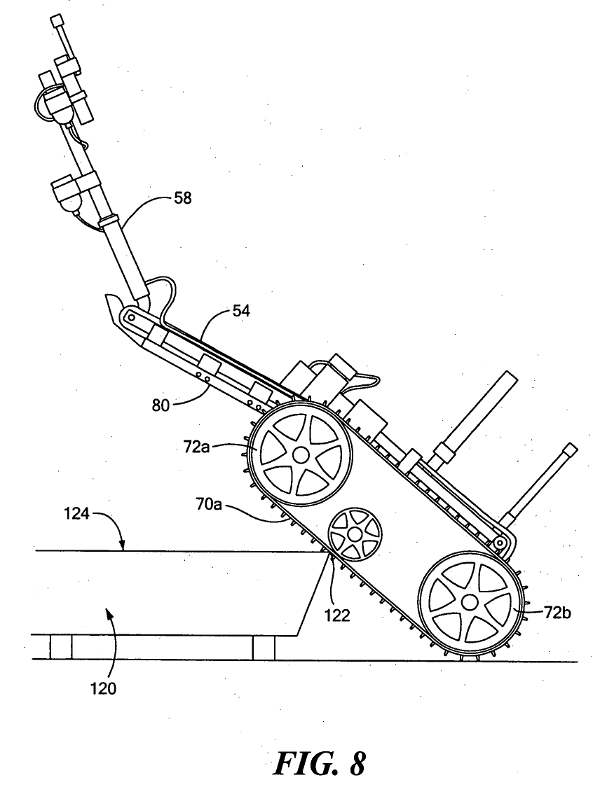

Also, robot 50, FIG. 8 can traverse high obstacle 120. Here, ski 80 was lowered to contact edge 122 of the riser of obstacle 120. This action raised wheel 72a sufficiently so track 70a was able to grip edge 122 and pull robot 50 up and onto surface 124. Arm 54 and 58 provide balance as the transition is made from the position shown in FIG. 8 until rear wheel 72b is on surface 124.

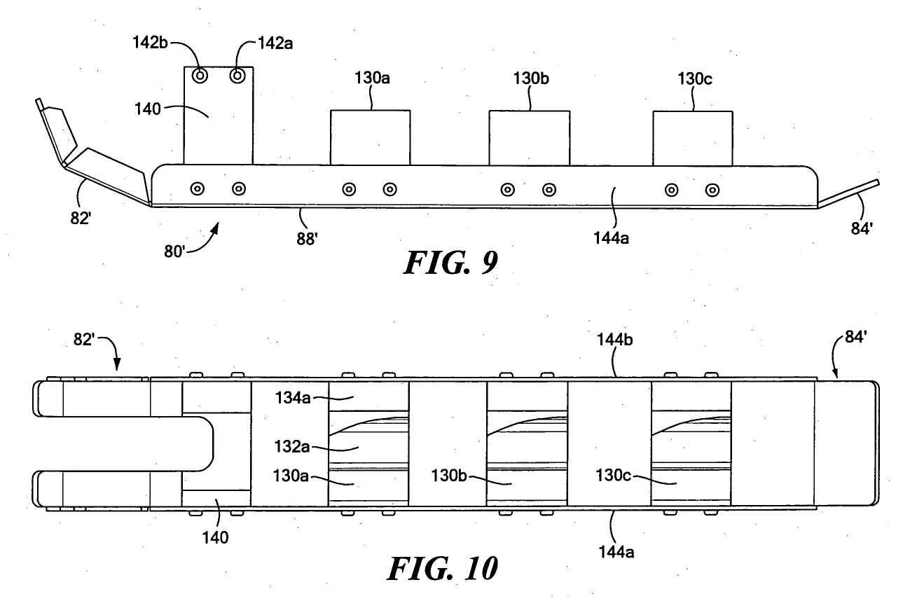

In another example, ski 80′, FIG. 9 includes split toe 82′, main body portion 88′, and tail 84′. It is preferred that ski 80′ be quickly attached and detached from the robot arm but the attachment mechanism will vary depending on the configuration of the robot arm. In this example, the robot arm is tubular in construction and snap fit receptacles 130a, 130b, and 130c, FIGS. 9-10 each include concave portions 132a as shown for receptacle 130a for frictionally receiving the tubular structure of the robot arm and slot 134a for receiving chain guard 86, FIG. 5. Arm 140 is provided for stability and may include orifices 142a and 142b for pins which releasably affix arm 140 to the robot arm.

Anodized aluminum ski 80′ in this example is 3″ wide but may be between 2″ and 4″ wide and is typically between 22″ to 23″ long. Side rails 144a and 144b may be included. Again, however, the configuration of the ski is expected to vary depending on the configuration of the robot arm it is attached to. It is preferred, although not necessary, that the ski structure includes upwardly angled forward toe 82′ and rearward upwardly angled tail 84′ to assist with the sliding action of the ski as the robot is maneuvered both forward and rearwardly up and down a staircase or obstacle.

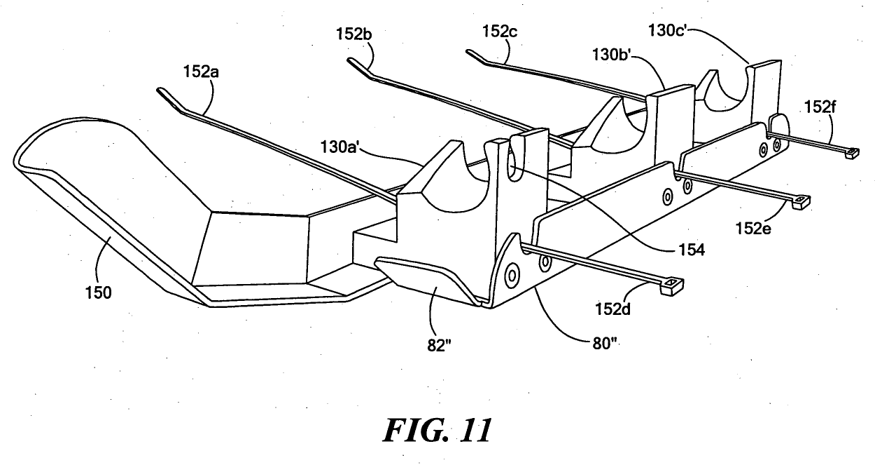

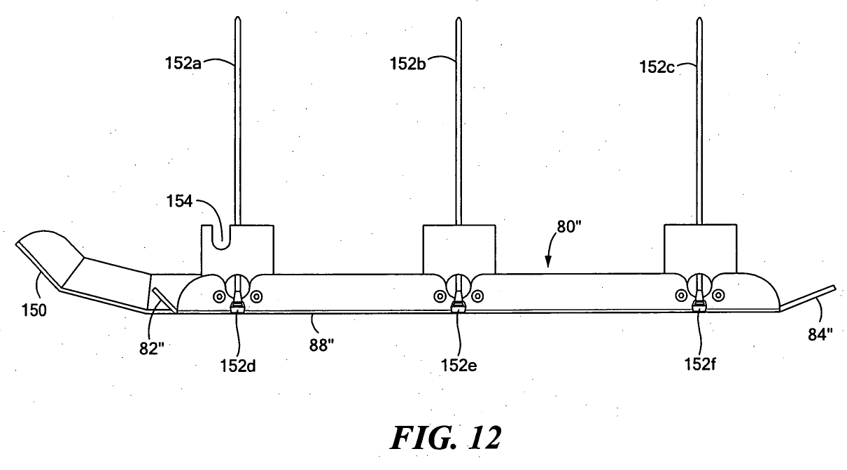

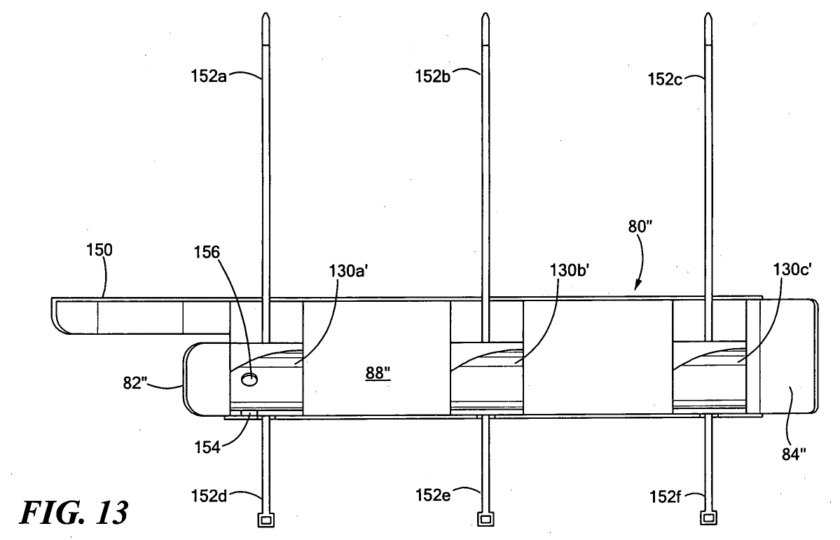

FIGS. 11-13 show another embodiment of ski 80″ with toe 82″, tail 84″, main body portion 88″, and forward chain guard protector portion 150. Snap fit receptacles 130a′, 130b′, and 130c′ are also shown. Cable ties 152a-152f assist in securing ski 80″ to the robot arm. Cut out feature 154 resides on a screw head on the robot arm to prevent ski 80″ from sliding with respect to the arm. Anti-rotational feature 156, FIG. 13 is typically an orifice that receives therein a second screw head on the robot arm to prevent rotation of ski 80″ about the robot arm.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A mobile robot comprising:
a chassis including one or more drive mechanisms;
at least a first arm pivotably connected to the chassis and configured to pitch up and down; and
a ski structure on an underside of the first arm for raising the chassis as the arm is pitched down so the drive mechanisms can traverse a riser in the path of the chassis.

2. The mobile robot of claim 1 in which the drive mechanisms include side tracks.

3. The mobile robot of claim 1 further including a second arm pivotably connected to the first arm.

4. The mobile robot of claim 1 in which the second arm includes at least one camera and at least one end effector.

5. The mobile robot of claim 1 in which the ski structure is releasably connected to the first arm.

6. The mobile robot of claim 1 in which the ski structure includes snap fit receptacles which receive therein structure of the first arm.

7. The mobile robot of claim 1 in which the ski structure includes a forward angled toe and a rearward angled heel.

8. The mobile robot of claim 1 in which the ski structure includes an anti-slide feature thereon for preventing sliding of the ski structure with respect to the robot arm.

9. The mobile robot of claim 8 in which the ski structure includes a snap fit receptacle which receives therein the first arm and the anti-slide feature includes a cut out in a side of the snap fit receptacle.

10. The mobile robot of claim 1 in which the ski structure includes an anti-rotation feature thereon for preventing rotation of the ski structure with respect to the robot arm.

11. The mobile robot of claim 10 in which the ski structure includes a snap fit receptacle which receives therein the first arm and the anti-rotation feature includes an orifice in the snap fit receptacle.

12. The mobile robot of claim 1 in which the ski structure includes a forward guard portion.

13. The mobile robot of claim 1 in which the ski structure includes ties for securing the ski structure to the first arm.

14. A method of climbing stairs with a mobile robot equipped with at least a first pivotable arm, the method comprising:
equipping the first pivotable arm with a ski structure;
maneuvering the mobile robot to a position proximate a set of stairs;
lowering the first pivotable arm until the ski structure contacts the tread of a stair; and
maneuvering the mobile robot closer to the stairs whereupon the ski structure causes the mobile robot to raise to a more suitable angle by which to climb the first stair.

15. The method of claim 14 further including the step of raising the first pivotable arm after the mobile robot begins to climb the stairs so as to not interfere with remaining stairs.

16. The method of claim 14 in which the robot includes side tracks.

17. The method of claim 14 in which the robot includes a second arm pivotably connected to the first arm.

18. The method of claim 14 in which the second arm includes at least one camera and at least one end effector.

19. The method of claim 14 in which the ski structure is releasably connected to the first arm.

20. The method of claim 19 in which the ski structure includes snap fit receptacles which receive therein structure of the first arm.

21. The method of claim 14 in which the ski structure includes a forward angled toe and a rearward angled heel.

22. A stair assist mechanism for a mobile robot, the mechanism comprising:
a ski structure including receptacles which receive therein an arm of the mobile robot;
a forward upwardly angled toe on the ski structure; and
a rearward upwardly angled heel on the ski structure.

23. The mechanism of claim 22 in which the ski structure includes an anti-slide feature thereon for preventing sliding of the ski structure with respect to the robot arm.

24. The mechanism of claim 23 in which the anti-slide feature includes a cut out in a side of a receptacle.

25. The mechanism of claim 22 in which the ski structure includes an anti-rotation feature thereon for preventing rotation of the ski structure with respect to the robot arm.

26. The mechanism of claim 25 in which the anti-rotation feature includes an orifice in the receptacle.

27. The mechanism of claim 22 in which the ski structure includes a forward guard portion.

28. The mechanism of claim 22 in which the ski structure includes ties for securing the ski structure to the robot arm.
